(19) United States
(12) Patent Application Publication
(10) Pub. No.: US 2023/0200961 A1
(43) Pub. Date: Jun. 29, 2023

(54) DENTAL SCANNING SYSTEMS

(71) Applicant: Align Technology, Inc., San Jose, CA (US)

(72) Inventors: David MASON, Morgan Hill, CA (US); William G. BECKER, Danville, CA (US)

(21) Appl. No.: 18/177,103

(22) Filed: Mar. 1, 2023

Related U.S. Application Data
(63) Continuation of application No. 16/374,648, filed on Apr. 3, 2019.
Application No. 16/374,648 is a continuation of application No. 12/283,770, filed on Sep. 16, 2008, now abandoned.

(51) Int. Cl. A61C 19/04; G09B 23/28

(52) U.S. Cl. CPC A61C 19/04; G09B 23/283; A61C 7/002

(57) ABSTRACT

Personal dental scanning systems for treatment of teeth are provided. These dental scanning systems may be configured for use by a user (e.g., patient) without requiring a dental professional and may include a scanner, a user input a user output, and one or more local or remote processors.

### CROSS REFERENCE TO RELATED APPLICATIONS

This application is a continuation of U.S. Pat. Application No. 16/374,648, filed Apr. 3, 2019, titled “DENTAL CONDITION EVALUATION AND TREATMENT,” now U.S. Pat. Application Publication No. 2019/0223992, which is a continuation of U.S. Pat. Application No. 12/283,770, filed Sep. 16, 2008, titled “DENTAL CONDITION EVALUATION AND TREATMENT,” now U.S. Pat. Application Publication No. 2010/0068676, each of which is herein incorporated by reference in its entirety.

### BACKGROUND

The present disclosure is related generally to the dental field. More particularly, the present disclosure is related to dental condition evaluation and treatment systems, apparatuses, and methods.

Dental condition evaluation and treatment are typically structured around an appointment with a treatment professional (e.g., dentist or orthodontist) at the treatment professional’s office. The user typically calls or stops by to make the appointment with a treatment professional because of their location, personality of the treatment professional, or who they know or were referred to.

A user seeking corrective treatment rarely has any idea before their appointment how much correction they need, what techniques can be used, or if that treatment professional has the experience to effectively treat their particular dental condition. Generally, if possible, a user would want the best treatment professional to treat them that is within their cost restraints.

The evaluation occurs when the treatment professional implements traditional diagnostic techniques, such as visually inspecting the user’s teeth, physically testing the structure and strength of the user’s teeth, and performing x-rays or other scans of the user’s teeth. The treatment professional then uses their learned knowledge to diagnose any dental conditions that the user may have and can be corrected.

The treatment professional can also consult other professionals in their field or research other’s work to help make the diagnosis of the user’s dental condition. The treatment professional ultimately makes a diagnosis of the user’s dental condition and recommends a corrective action to the user.

The user’s treatment options are limited to those recommended by the treatment professional which often times are those that the treatment professional is capable of performing and not necessarily all the reasonable options. In order for the user to benefit from the appointment, office visit, and diagnosis, the user has to use that particular treatment professional to implement the treatment plan and pay the treatment professional’s rates for their service. The user must visit other treatment professionals to receive further diagnosis or treatment options.

### BRIEF DESCRIPTION OF THE DRAWINGS

FIG. 1 illustrates a method embodiment for evaluating a dental condition according to an embodiment of the present disclosure.

FIG. 2A illustrates an embodiment of a digital model of a set of teeth created according to an embodiment of the present disclosure.

FIG. 2B illustrates a cross sectional view of an embodiment of the digital model of the set of teeth created according to an embodiment of the present disclosure.

FIG. 3 illustrates a method embodiment for proving an automated analysis process of a user’s teeth for evaluating a dental condition according to an embodiment of the present disclosure.

FIG. 4 illustrates a computing device embodiment to perform a method embodiment for evaluating a dental condition according to an embodiment of the present disclosure.

### DETAILED DESCRIPTION

Embodiments of the present disclosure provide various methods, apparatuses, and systems for providing a dental condition evaluation. Various embodiments include, for example, taking a scan of a user’s teeth, creating a digital model of the user’s teeth, evaluating the user’s teeth, developing a treatment plan for a dental condition of a user including one or more treatment best match criteria, and identifying a treatment professional for initiation of the treatment plan based on selection best match criteria for the initiation phase.

Embodiments of the present disclosure are described in relation to the accompanying drawings, which will at least assist in illustrating the various features of the various embodiments. In the Figures, the first digit of a reference number refers to the Figure in which it is used, while the remaining two digits of the reference number refer to the same or equivalent parts of embodiment(s) of the present disclosure used throughout the several figures of the drawing.

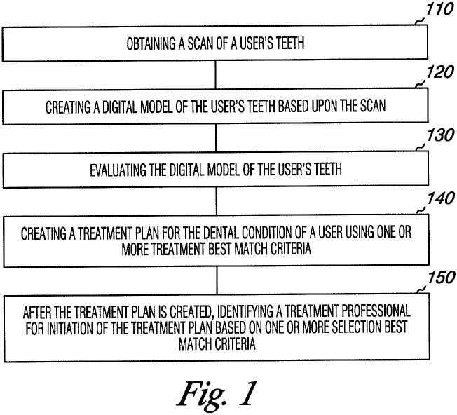

FIG. 1 illustrates a method embodiment for evaluating a dental condition according to an embodiment of the present disclosure. In FIG. 1, the method for evaluating a dental condition includes scanning a user’s teeth 110. The process of scanning a user’s teeth 110 allows for information regarding the shape and condition of the user’s teeth to be recorded via the scan, among other benefits.

The scan can, for example, include taking pictures of the user’s teeth, performing an intraoral scan of the user’s teeth, and/or a cone scan of the user’s teeth, among other scanning techniques. The data acquired during the scan of the user’s teeth can be used, for example, to evaluate the user’s teeth and/or to diagnose any dental conditions that the user may have.

In some embodiments, a method includes creating a digital model of the user’s teeth based upon the scan 120. The digital model can be created, for example, by a computing device having executable instructions to manipulate the data from the scan into a digital representation of the user’s teeth.

In some embodiments, the digital model can form a three-dimensional (3D) image of the user’s teeth or a portion thereof on the computing device, allowing, for example, views of the user’s teeth from any perspective. In various embodiments, the digital model can allow for various two dimensional (2D) views of the user’s teeth, along with cross sectional views of the user’s teeth. In some embodiments, the 3D image can be segmented to create independent representations of each of the segmented teeth.

The segmentation can be used to create individual digital model data for each tooth which can be stored in an individual data file for each tooth or can be defined within a larger data file for multiple teeth. This can allow for the teeth to be oriented individually with respect to the other teeth as part of the formation of a treatment plan. The scanning of the teeth and/or segmenting of the teeth can be accomplished before the patient visits the treatment professional which can aid in providing the information before the initial visit so that the initial visit time can be spent, for example, on discussing treatment planning versus the collection of the data needed to determine the treatment plan.

In various embodiments, a method can include evaluating the digital model of the user’s teeth 130. The evaluation method can, for example, include a treatment professional observing the digital model for dental conditions of the user that can be corrected.

In some embodiments, the evaluation method can, for example, include an automated analysis process for the digital model of the user’s teeth. The automated analysis process can, for example, include computing device executable instructions to compare the digital model of the user’s teeth to a case history database. This comparison can be used to determine what types of movement and/or treatment should be used in the treatment plan. Such decisions can be made, for example, by a treatment professional in review of the comparison information (e.g., in the form of data and/or a representation of the comparison).

In some embodiments, the evaluation can include comparing the digital model with a database containing the digital models of prior cases. The digital models of prior cases can include, for example, models of other user’s teeth with their prior conditions and/or models of other user’s teeth while a treatment plan is being performed up to the final state of other user’s teeth at completion of the treatment plan.

In some embodiments, the use of the case history database of digital models of prior cases can, for instance, allow the treatment professional to predict the response of the user’s teeth to various treatment plans and/or to identify an appropriate treatment plan for the user based on the effectiveness of the treatment plans implemented in the preexisting cases.

In some embodiments, a method includes creating a treatment plan for a dental condition of the user including one or more treatment best match criteria 140. In various embodiments, creating a treatment plan for a dental condition of the user including one or more best match criteria 140 can include determining the corrective action that is necessary to bring about the desired result.

For many users, the desired result is repositioning of the user’s teeth. This can be accomplished, for example, by applying pressure to the user’s teeth to force them to move to a desired position. There are many techniques and strategies that a treatment professional can use to achieve this repositioning of the user’s teeth. Treatment plans that are created by the treatment professional and/or through utilization of an automated process can outline, for example, the steps and/or methods that will be used throughout the treatment process to achieve a desired end result.

In some embodiments, the treatment plan can include a mixed treatment that can include using an aligner, braces, and/or restorative work to treat the dental condition of the user. The treatment best match criteria used to create a treatment plan for the user can include one or more treatment plan criteria such as treatment plan cost, treatment plan length, treatment plan complexity, and/or treatment plan comfort.

In some embodiments, the digital model of the user’s teeth can be sent to an analysis center and evaluated at the analysis center to create the treatment plan for the dental condition of the user based on one or more of the best match criteria. In various embodiments, the treatment plan can be created through use of an automated analysis process, as discussed above, that compares the digital model of the user’s teeth to a case history database, along with considering the best match criteria of the user.

In various embodiments, a method can include identifying a treatment professional for initiation of the treatment plan based on one or more of the best match criteria 150. In some embodiments, once the digital model of the user’s teeth has been evaluated and a dental condition that can be treated is identified, one or more potential treatment professionals that can perform the treatment plan are selected. For example, in some embodiments, once the digital model has been evaluated, the user can be given a list of treatment professionals that not only meet the treatment plan criteria, but also meet one or more personal selection best match criteria.

The personal selection best match criteria for determining the best treatment professional may include a number of additional factors. For example, in some embodiments, the user may rank their personal importance of personal best match criteria, including the treatment professional’s proximity to the user’s home, work, and/or hospital; the treatment professional’s hours of operation on certain days and/or times of the day; the financial options provided by the treatment professional; the languages communicated by the treatment professional; the education and/or credentials of the treatment professional; the general and/or specific surgical experience of the treatment professional; the ability of the treatment professional to treat patients with mixed dentition; and/or the treatment professional’s practice focused on pre-teens, teens, and/or adults, among other criteria.

In some embodiments, the user can rank these personal selection best match criteria through a number of questions allowing the best match treatment professional to be found for the user’s dental condition. Thus, the user will be provided with a ranked list of treatment professionals that will not only meet the treatment plan criteria, but also meet their personal criteria.

In various embodiments, a best match criteria process could be used to have the user rank the personal selection best match criteria for treatment planning and personal preferences. In such embodiments, the ranking of the personal best match criteria can limit the number of personal best match criteria to select from based on treatment professionals that meet the treatment plan criteria for the dental condition. In other words, if the treatment professionals that match the treatment plan criteria do not have financial options, for example, this personal criterion may be shown but not operative.

In some embodiments, a list of treatment professionals may be provided, where each criterion not met can be listed by the treatment professional’s name. In some embodiments, a chart may be provided to indicate the treatment professionals that can correct the user’s dental condition in one column and the remaining columns indicate if the treatment professionals meet the other best match criteria. In some embodiments, the user may be given the option to change their criteria ranking in the event that a treatment professional cannot be found with all criteria.

The use of these criteria may be implemented by an individual that helps select qualified treatment professionals based on the criteria and/or through use of computer executable instructions that can evaluate the criteria to aid in selection of a treatment professional. For example, the criteria can be weighted based upon the rank given by the patient and this weighting can be used to sort the treatment professionals based upon their qualifications which can be stored in a database. There are many other methods of using these criteria and any such method may be suitable in one or more embodiments of the present disclosure.

In some embodiments, the user and a selected treatment professional can communicate further to determine a plan to start the implementation of the treatment plan through further consultation with the treatment professional, arranging payment plans, and/or physically starting to apply the treatment plan to the user’s dental condition.

In various embodiments, once the user has determined the treatment professionals that can provide the treatment plan and can meet their personal best match criteria, these treatment professionals can be given the option of bidding a price for which they will provide the services to implement the treatment plan. In some embodiments, the bidding process can include treatment professionals submitting a bid where the treatment professionals do not know the bids of other treatment professionals.

This process can be handled, for example, by executable instructions for receiving the bids and/or selecting or recommending a bidder to do the treatment. In some embodiments, the bids can be provided to the user for their selection of a treatment professional.

In various embodiments, the user can then be matched with the treatment professional, for example with the lowest bid, to implement the treatment plan. In some such embodiments, the user can view the bids of each of the treatment professionals and choose the treatment professional with the best combination of price and the user’s personal best match criteria.

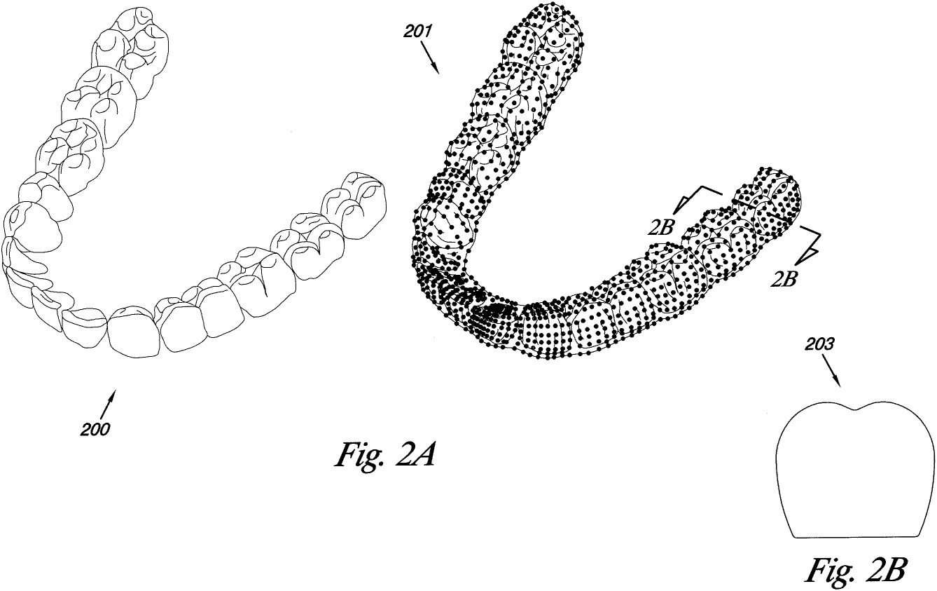

FIG. 2A illustrates an embodiment of a digital model of a set of teeth created according to an embodiment of the present disclosure. In various embodiments, the user’s teeth 200 can be scanned by taking pictures, by taking X-rays, by an intraoral scan, and/or by a cone beam scan or by scanning an impression of a user’s teeth, among other processes.

The information related to the user’s teeth 200 gathered by the one or more scanning techniques can then be used to form a digital model of the user’s teeth 201. The digital model of the user’s teeth 201 provides, for example, a digital image of the actual user’s teeth 200 that maps the outside surface of the teeth 200 to allow 360.degree. viewing of the teeth 200. The digital model 201 can then be studied by a treatment professional to determine if a dental condition exists with the user’s teeth 200, which can be easier and can be more thoroughly studied for longer time periods than looking into the mouth of the user and/or while the user is at the treatment professional’s office.

FIG. 2B illustrates a cross sectional view of an embodiment of the digital model of the set of teeth created according to an embodiment of the present disclosure. In various embodiments, the digital model of the user’s teeth can show a cross sectional view of the user’s teeth 203.

This view can be beneficial to the treatment professional, for example, in evaluating the user’s teeth and diagnosing and forming a treatment plan for a dental condition of the user. The cross sectional view of the user’s teeth 203 can provide a unique perspective of the user’s teeth that is not available through traditional methods, such as visual inspection of pictures of the user’s teeth. In some embodiments, the interior view can show a portion or all of the root structure of one or more teeth and/or the interior structure of one or more teeth.

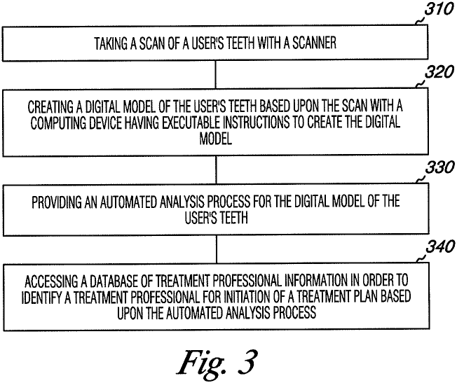

FIG. 3 illustrates a method embodiment for proving an automated analysis process of a user’s teeth for evaluating a dental condition according to an embodiment of the present disclosure. In the embodiment of FIG. 3, the method includes taking a scan of a user’s teeth with a scanner 310.

In some embodiments, the scanning of the user’s teeth 310 can be completed by the user. This is can be accomplished, for example, by making the scanning equipment available or providing the equipment to the user.

In such embodiments, the user can be instructed to operate the scanning equipment, to allow the information to be gathered and stored for further manipulation and/or analysis during the evaluation process. Such embodiments give the user the convenience in choosing when and/or where to scan their teeth.

In various embodiments, the scanning of the user’s teeth 310 can be performed at a public station. The public station can be provided, for example, as a kiosk at a mall, a store, a public lab, or any other public place. The public station can include a kiosk or a person assisted station where a user has their teeth scanned (e.g., pictures, intraoral, cone) and/or evaluated.

The embodiment of FIG. 3 includes creating a digital model of the user’s teeth based upon the scan with a computing device having executable instructions to create the digital model 320. In various embodiments, a digital model of the user’s teeth can, for example, be created by executable instructions on a computing device readable medium that take the data gathered during the scan of the user’s teeth and form a digital model that represents the user’s teeth.

Such digital models can, for example, be viewed and manipulated on a computing device. The ability of the digital model to be viewed on a computing device allows, for example, for the multiple views of the user’s teeth and/or allows for portability in viewing the user’s teeth.

Digital models of the user’s teeth can be viewed on any computing device that is capable of performing the executable instructions associated with the digital model. Digital models can also be stored and transferred electronically to other computing devices. These features, associated with one or more digital models of the user’s teeth can, for example, allow for flexibility in evaluating the user’s teeth, as multiple treatment professionals can view and/or diagnose the user’s teeth at any time and/or potentially from many viewing perspectives.

The embodiment of FIG. 3 includes providing an automated analysis process for the digital model of the user’s teeth 330. The automated analysis process can include executable instructions to compare the digital model of the user’s teeth to the case history database.

The comparison of the digital model and the case history database can allow the condition of the user’s teeth to be compared an/or matched to one or more previous patient’s teeth. The comparison and/or matching can be used to identify one or more prior patients that had a dental condition that is the most similar to the dental condition of the user’s teeth.

A diagnosis can be made, for example, based on the similarities between and/or match, and a potential treatment plan can be recommended, in some embodiments, based on the prior patient’s treatment plan. Such diagnosis and/or potential treatment plans can be automated by employing one or more executable instructions to perform such a process as described herein.

In some embodiments, an automated analysis process can take place via a computing device that is positioned at a public station. The executable instructions to perform the automated analysis can be performed at one or more computing devices.

As such, the one or more computing devices can be located at a public station. Such computing devices can perform the automated analysis, for example, by comparing the digital model to the case history database (e.g., database of prior cases) that is on a network the computing device is connected to and/or the computing device can have the case history database electronically stored on the device, in some embodiments Automated analysis at a public station, can allow a user to get immediate feedback regarding their dental condition, such as when the user has just completed the scan of their teeth at the public station, among other benefits.

In some embodiments, the automated analysis process uses a case history database to analyze the digital model of the user’s teeth and/or to assign a complexity level for the dental condition of the user’s teeth. In various embodiments, the automated analysis can include the assignment of a complexity level of the dental condition of the user.

For example, the complexity level can be derived from a comparison of a digital model of the user’s teeth with prior patient’s case files in a case history database. In some such embodiments, a case in the case history database may have a complexity level included in the data and that level can be used to determine the complexity level of the patient’s case. In some embodiments, a treatment professional can assign the complexity level, for example, after comparing the patient’s case with one or more prior cases.

A complexity level can be used, for example, to determine potential treatment plans that have been successful in treating similar dental conditions in prior patients, in some embodiments. In various embodiments, a complexity level can be used as a guideline to predict the length of the treatment and/or also the cost of the treatment, among other uses.

In some embodiments, the complexity level of the dental condition of the user’s teeth can be used to develop a visual representation of a treatment plan. A complexity level can be used to identify the steps of a proposed treatment plan, which can then, for example, be represented in a visual model, in some embodiments.

The visual model can, in various embodiments, illustrate the steps of the treatment plan and/or illustrate the progression throughout the treatment plan which can be viewed by the treatment professional and/or the patient. In some embodiments, a complex treatment plan may involve a lot of steps. These steps can be visually illustrated to the patient to allow the patient to understand what will occur during the treatment plan.

The embodiment of FIG. 3 can include accessing a database of treatment professional information in order to identify a treatment professional for initiation of a treatment plan based upon the automated analysis process 340. In various embodiments, once a user’s teeth have been evaluated, a treatment professional that can perform a recommended treatment plan can be identified.

The treatment professional can be identified from a list or database of treatment professionals that can provide the services to perform the recommended treatment plan.

In some embodiments, the list or database of treatment professionals can be customized or narrowed to include treatment professionals that are located within a certain geographic vicinity of the user, perform the services for the desired treatment plan, meet a desired cost criteria of the user, and/or any other criteria that the user would like to differentiate available treatment professionals. This type of selection can be accomplished via a user interface and/or executable instructions, for example.

In some embodiments, a user can receive a list of treatment professionals that can provide the treatment plan. The user can, for example, receive a list of the treatment professionals that can provide the services to accomplish the treatment plan and/or those having the necessary training to perform the treatment.

In various embodiments, the list can be customized to the user based on one or more selection best match criteria they would like their treatment professional to meet, as discussed above. In some embodiments, the list can, for example, provide detailed information about the treatment professional, such as their location, cost, and/or experience, among other characteristics a user would desire to know. In various embodiments, the user can be allowed to select a treatment professional from the list, if they choose to implement the treatment plan that was recommended to them.

In some embodiments, the user can initiate the treatment plan with one or more of the treatment professionals on the list. For example, the user can evaluate the treatment professionals from the list and once the user has selected a treatment professional they would like to work with, the user can initiate the treatment plan with the selected treatment professional.

For example, the user can set up one or more appointments with the treatment professional and the treatment professional can begin to apply the treatment plan to the user’s dental condition. The treatment professional can have knowledge of the user’s dental condition prior to their first appointment because the digital model of the user’s teeth can be sent to the treatment professional before the appointment, along with a recommended treatment plan, in various embodiments.

In some embodiments, the user can receive a promotion such as a rebate, other discount or free or discounted accessory or other products or services for purchasing or even visiting a treating professional regarding a treatment plan based on the initiation of the treatment plan. For example, as part of the evaluation process, a list of treatment professionals that can perform the recommended treatment plan is given to the user. As an incentive for the user to choose one of the treatment professionals from the list to perform the treatment plan, a rebate on the cost of the treatment plan can be given to the user for selecting a treatment professional from the list. Such a promotion can be for any chosen professional or can be individualized offerings by each professional.

In some embodiments, the user can apply for financing with a financial credit application to pay for the treatment plan. In many cases, the treatment plans for the dental condition of a user can be expensive.

Therefore, many users may not have cash on hand to pay for the treatment plan immediately. Accordingly, in some embodiments, as part of the evaluation process, the user can fill out a financial credit application. The financial credit application can, for example, be analyzed to determine if the user is credit worthy to receive a loan to pay for the treatment plan or if a payment plan could fit in with the user’s financial wherewithal, in various embodiments.

In some embodiments, the financial credit application can, for example, be used to determine the user’s ability to pay for the treatment of the dental condition. The financial credit application can, for instance, be used to analyze the ability of user to pay for a treatment plan.

In some embodiments, this information can be used to determine a list of treatment professionals that the user could afford to perform the treatment plan, among other uses. The financial credit application can be used to determine if the user is a suitable candidate for a treatment plan, in various embodiments.

In some embodiments, the financial credit application can be used to find the user a financing method to pay for the treatment of the dental condition. In many cases, where the user does not have cash to pay for the treatment plan or wishes to not spend their cash on the treatment plan, the financial credit application can be used to locate various financing options for the user.

In some such embodiments, the information from the financial credit application can be forwarded to one or more financial institutions which can offer financing options to the user. In some embodiments, the treatment professionals that are on the list given to the user can use the financial credit application information to offer their own financing and/or payment plan for the treatment plan that they are to provide.

In some embodiments, insurance information can be used to aid in selecting the treatment professional or in determining what coverage may exist for a treatment. For example, if only certain treatment professionals accept the user’s insurance for that treatment, that information may be identified on the list given to the user or the list may only include those professionals. Also, the amount, if any, of insurance coverage may be predetermined.

In some embodiments, computing device executable instructions can include instructions that allow the user to sign up for the treatment plan with one or more of the treatment professionals on the list by providing user contact information to a selected treatment professional via executable instructions from a computing device to a treatment professional computing device associated with the selected treatment professional. A user can, for example, receive a list of treatment professionals that can provide the recommended treatment plan.

In some such embodiments, a user can select one or more of the treatment professionals and sign up with the selected treatment professionals electronically. In some embodiments, the user can sign up for the treatment plan with a selected treatment professional at a public station where the user had their teeth scanned.

In some embodiments, identifying a treatment professional for initiation of the treatment plan can include referring the user to a treatment professional for implementation of the treatment plan. The list of treatment professionals that can perform the recommended treatment plan can be used to refer the user to a specific treatment professional from the list.

The referral can, for example, be based on a number of criteria, as discussed above, and can be made based on the treatment professional meeting one or more of the criteria. The criteria can, for example, be based on desires of the user, such as location, cost, and/or experience. Criteria can, for example, be based on the preferences of the treatment professionals to work on certain types of dental conditions, with certain types of patients, and/or to perform certain types of treatment plans and/or processes and availability at certain times of the year.

Some embodiments can include creating a digital model of the user’s teeth based upon a scan. In various embodiments, the scan can, for example, include taking pictures of the user’s teeth, taking X-rays, performing an intraoral scan of the user’s teeth, and/or a cone beam scan of the user’s teeth or taking a scan of an impression of a user’s teeth, among other scanning techniques. The data acquired during the scan of the user’s teeth can be used to evaluate the user’s teeth and/or to diagnose any dental conditions that the user may have. The digital model can be created by a computing device having executable instructions to manipulate the data from the scan into a digital representation of the user’s teeth.

As discussed above, the digital model can form on a three-dimensional (3D) image of the user’s teeth or one or more portions thereof on the computing device, allowing views of the user’s teeth from any perspective. The digital model can also allow for various two dimensional (2D) views of the user’s teeth, along with cross sectional views of the user’s teeth.

Some embodiments can include sending the digital model of the user’s teeth to an analysis center. In various embodiments, the analysis center can be remotely located from the computing device where the scan of the user’s teeth was performed.

The analysis center can be designed to have access to the case history database to allow the automated analysis to take place at the analysis center based on the prior patient’s case files. The analysis center can be designed to include a number of treatment professionals on site to view the digital model and to render their opinion regarding the dental condition of the user’s teeth.

In some embodiments, the analysis center allows for the evaluation to take place at a centralized location and/or can have a number of treatment professionals perform their evaluation and/or compare it to the automated evaluation. The centralized nature of the automated and/or treatment professional evaluations at the analysis center allows the user to get a diagnosis that can be thorough and/or sophisticated in a short time frame.

Various embodiments include evaluating the digital model of the user’s teeth. In some embodiments, evaluating the digital model of the user’s teeth provides a method to diagnose one or more dental conditions that the user has and a method to develop one or more treatment plans that can correct the dental condition.

As discussed above, in some embodiments, the evaluation of a digital model can include comparing the digital model of the user’s teeth with a case history database. The case history database may include, for example, the patient files of prior patients.

The patient files can include digital models of prior patient’s teeth to compare with a digital model of the user’s teeth. In some embodiments, the patient files can contain information relating to the treatment that the prior patients received to correct various dental conditions.

The information relating to the treatment that prior patients received can include one or more before and/or after pictures and/or digital models, a length of the treatment, and one or more methods used to treat the dental condition, and/or other pertinent information that related to the diagnosis and/or treatment of dental conditions of prior patients.

The prior patient’s data included in the database can, for example, include data regarding prior patients that a particular treatment professional has treated and/or it can include data regarding prior patients of a network of treatment professionals that are sharing one or more case history databases. The network of shared prior patient data in the case history database can give a treatment professional in a network a large amount of information to use as they diagnose a dental condition of a user while evaluating a digital model of the user’s teeth.

In some embodiments, a number of treatment professionals can analyze the treatment plan to develop a recommendation as to the complexity of the case. The analysis of the user’s teeth can, in various embodiments, include multiple treatment professionals giving their opinion regarding the dental condition of the user’s teeth.

In some embodiments, the digital model of the user’s teeth can be sent to a number of treatment professionals who collaborate together. This collaboration can allow a user to receive multiple opinions regarding their dental condition, while just having their teeth scanned once while visiting a treatment professional or scanning their own teeth at a public station. The collaboration between the treatment professionals can, for example, allow the user to receive a more thorough diagnosis, as the knowledge and experience of the treatment professionals can be combined, or perhaps a broader range of treatment alternatives.

Some embodiments can include determining whether the user is a suitable candidate for a treatment plan. In various embodiments, a treatment plan can be created based on the evaluation of the dental condition of the user. The treatment plan can include the steps and methods involved in treating the dental condition of the user, such as the hardware that will be used.

In various embodiments, the treatment plan can include a schedule or time line for the treatment plan, including scheduled office visits to the treatment professional. In some embodiments, the treatment plan can include a price estimate for the treatment that is based on the complexity of the treatment, the treatment professional performing the treatment, the time frame of the treatment, and/or the hardware that is used during treatment of the dental condition.

In some embodiments, an automated analysis process creates the treatment plan based upon the scan of the user’s teeth. The automated analysis process can be designated to include formulating a treatment plan.

For example, a treatment plan can be created based upon the comparison of the digital model of the user’s teeth to a case history database. Various prior treatment plans of prior patients can be stored in the case history database, in some embodiments.

The treatment plan can be derived, for example, from the treatment plans of one or more prior patients by comparing dental conditions of one or more prior patients to their response to various treatment plans applied to one or more prior patient’s dental conditions. Prior treatment plans that were used to treat dental conditions that are similar to the user’s dental condition can be identified and used as part of the treatment plan that is generated during the comparison of a digital model to prior cases in an automated analysis process (e.g., via computing device executable instructions).

In some embodiments, executable instructions include instructions to generate a representative result of one or more steps of the treatment plan that can be shown to the user, for example, representing an intended potential outcome of the treatment plan.

For example, the intended result can be shown to the user as a representative result of a treatment plan if implemented to correct the user’s dental condition. The user can, for example, utilize the representative result to make the decision regarding the correct treatment plan to use and if they would be satisfied with a given treatment plan.

Once a treatment plan that can correct the user’s dental condition is identified, the determination of whether the user is suitable candidate can be made. The first step is determining if a treatment plan is available. Once a treatment plan is identified, the second step is determining if the user has the financial means to pay for the treatment plan. If the user has the ability to pay for the treatment plan, then the user may be deemed be a suitable candidate for the implementation of a treatment plan.

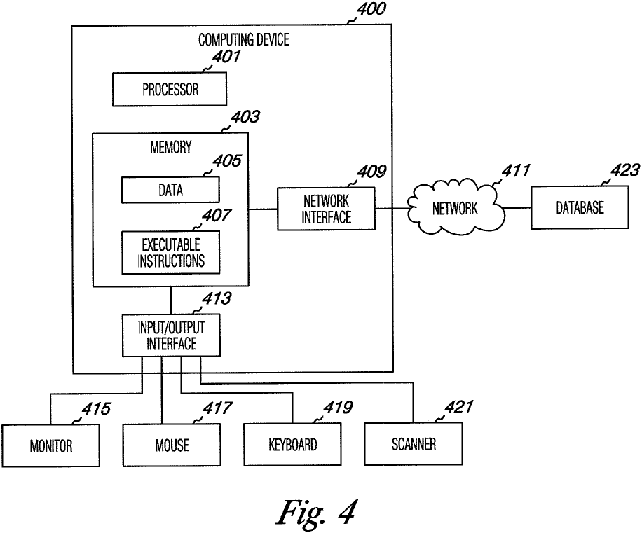

FIG. 4 illustrates a computing device embodiment to perform a method embodiment for evaluating a dental condition according to an embodiment of the present disclosure. The computing device 400 illustrated in FIG. 4, includes a processor 401 and memory 403. Memory 403 can include various types of information including data 405 and computing device executable instructions 407 as discussed herein.

Memory can be used for a variety of different functions in the various embodiments. For example, memory can be used to store executable instructions that can be used to interact with the other components of the computing device and/or network including other computing devices and can be used to store information, such as instructions for manipulating one or more files.

For instance, in some embodiments, a computing device can include executable instructions for saving a number of program and/or data files, such as files, for providing executable instructions that allow for the viewing functionality for viewing scans and/or models, and the data files for the scans and/or digital models. Some executable instructions can, for example, be instructions for saving local scans and/or digital models, scans and/or digital models from another computing device on the network, or a combination of two or more of these.

Additionally, as illustrated in the embodiment of FIG. 4, a system can include a network interface 409. Such an interface can allow for processing on one or more networked computing devices or such devices can be used to transmit and/or receive scans and/or digital models and/or executable instructions for use with various embodiments provided herein.

The network interface 409 can connect the computing device to a network 411. The network 411 can be connected to other computing devices that can execute scans and/or digital models of the user’s teeth.

The digital model obtained from a scanner that is interfaced with computing device 400 can be sent on the network 411 to other computing devices. A number of treatment professionals can have access to the computing devices on the network 411 so they can view and diagnose the dental condition of a user based on the digital model from a remote location.

In the embodiment of FIG. 4, the network 411 is connected to a database 423. The database 423 can, for example, include a case history database that can give access to prior patient’s data to use in the evaluation and treatment process. In such embodiments, treatment professionals that have access to the network 411 and in turn the database 423 can use the case history database to supplement their evaluation and treatment of a user’s dental condition.

As illustrated in the embodiment of FIG. 4, a system can include one or more input and/or output interfaces 413. Such interfaces can be used to connect the computing device with one or more input and/or output devices.

For example, in the embodiment illustrated in FIG. 4, the system includes connectivity to a monitor 415, a mouse 417, a keyboard 419, and a scanner 421. The scanner 421 can be used to scan the user’s teeth. The data from the scan of the user’s teeth can be used to form a digital model of the user’s teeth, which treatment professionals can use to diagnose a dental condition of the user’s teeth.

Such connectivity on the network 411 can allow for the input and/or output of manipulations (e.g., changes to the common file embedded in executable instructions) among other types of information. Although some embodiments may be distributed among various computing devices within one or more networks, such systems as illustrated in FIG. 4, can be beneficial in allowing for the capture, calculation, and/or analysis of the various information discussed herein.

Various embodiments include the use of executable instructions to accomplish one or more processes. Such instructions can, for example, be implemented on one or more computing devices and therefore in such embodiments, the executable instructions should be viewed as being computing device executable instructions for implementation by one or more computing devices.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the use of the terms “a”, “an”, “one or more”, “a number of”, or “at least one” are all to be interpreted as meaning one or more of an item is present. Additionally, it is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A dental scanning system comprising:
a tooth scanner configured for a user to scan their own teeth;
a user input interface;
a user display;
one or more processors in communication with the user input interface and the user display; and
a non-transitory computer-readable medium storing instructions that are executable by the one or more processors, wherein the instructions, when executed by the one or more processors, cause the one or more processors to:
create and store a digital model of the user’s teeth based on a scan data gathered using the tooth scanner;
receive a selection of one or more best match criteria from the user, the one or more best match criteria including one or more of treatment plan complexity, treatment plan length, treatment plan comfort, and treatment plan cost;
create a treatment plan for the user’s teeth based on a comparison between the digital model of the user’s teeth with a database containing digital models of prior cases and the user selected one or more treatment best match criteria;
receive selections of personal selection best match criteria in from the user input interface, the personal selection best match criteria identifying a user’s preferences related to characteristics of a treatment professional; and
display on the user display, after the treatment plan is created and the personal selection best match criteria are received, a list of treatment professionals for initiation of the treatment plan, wherein the list is based on the treatment plan and the personal selection best match criteria.

2. The dental scanning system of claim 1, wherein the instructions, when executed by the one or more processors, further cause the one or more processors to generate and display one or more visual representations of the treatment plan on the user display.

3. The dental scanning system of claim 1, wherein the instructions, when executed by the one or more processors, further cause the one or more processors to generate and display a representation of progress throughout the treatment plan and a potential outcome of the treatment plan over a given timeframe.

4. The dental scanning system of claim 1, wherein the instructions, when executed by the one or more processors, further cause the one or more processors to provide user contact information to a selected treatment professional.

5. The dental scanning system of claim 1, wherein creating the treatment plan comprises determining types of tooth movement, whether the treatment plan includes mixed treatment, and whether the treatment plan includes restorative work.

6. The dental scanning system of claim 1, wherein the instructions, when executed by the one or more processors, further cause the one or more processors to segment the digital model and create independent representations of each tooth of the digital model.

7. The dental scanning system of claim 1, wherein creating the treatment plan includes:
identifying one or more dental conditions of the prior cases that are similar to the dental condition of the user’s teeth;
assigning a complexity level of the treatment plan based on similarities of the dental condition of the user’s teeth and the one or more similar dental conditions of the prior cases;
identifying steps of the treatment plan based on the complexity level; and
individually orienting a digital representation of each tooth with respect to digital representations of other teeth of the digital model according to the steps of the treatment plan.

8. The dental scanning system of claim 1, wherein the personal selection best match criteria include at least one criterion selected from the group: treatment professional’s proximity to one or more of the user’s home, work, or hospital; treatment professional’s hours of operation on one or more of certain days or times of the day; one or more financial options provided by the treatment professional; one or more languages communicated by the treatment professional; education of the treatment professional; credentials of the treatment professional; surgical experience of the treatment professional; ability of the treatment professional to treat patients with mixed dentition; or the treatment professional’s practice focused on one or more of pre-teens, teens, or adults.

9. The dental scanning system of claim 1, wherein the instructions, when executed by the one or more processors, further cause the one or more processors to rank the personal selection best match criteria based on the user’s preferences.

10. The dental scanning system of claim 1, wherein the dental scanning system is at a public station.

11. A dental scanning system comprising:
a user input interface;
a user display; and
a computer network including a local computer associated with the intraoral scanner and one or more remote computers operatively connected to the local computer, wherein:
the local computer is configured to:
create and store a digital model of the user’s teeth based on a scan data gathered using the intraoral scanner;
receive a selection of one or more best match criteria from the user, the one or more best match criteria including one or more of treatment plan complexity, treatment plan length, treatment plan comfort, and treatment plan cost;
receive selections of personal selection best match criteria in from the user, the personal selection best match criteria identifying a user’s preferences related to characteristics of a treatment professional; and
send the digital model, the selected one or more best match criteria, and the selected personal selection best match criteria to the one or more remote computers; and
receive a list of treatment professionals for initiation of a treatment plan from the one or more remote computers and present the list to the user; and
the one or more remote computers is configured to:
receive the digital model from the local computer and create a treatment plan for the user’s teeth based on a comparison between the digital model with a database containing digital models of prior cases and the received one or more treatment best match criteria;
generate, using the treatment plan and the receive personal selection best match criteria, the list of treatment professionals for initiation of the treatment plan, and sending the list of treatment professionals to the local computer.

12. The dental scanning system of claim 1, wherein the digital models of prior cases include digital models of other users’ teeth with their prior conditions and digital models of the other users’ teeth while their treatment plan is being performed.

13. The dental scanning system of claim 1, wherein the personal selection best match criteria include at least one criterion selected from the group: treatment professional’s proximity to one or more of the user’s home, work, or hospital; treatment professional’s hours of operation on one or more of certain days or times of the day; one or more financial options provided by the treatment professional; one or more languages communicated by the treatment professional; education of the treatment professional; credentials of the treatment professional; surgical experience of the treatment professional; ability of the treatment professional to treat patients with mixed dentition; or the treatment professional’s practice focused on one or more of pre-teens, teens, or adults.

14. The dental scanning system of claim 1, wherein the one or more remote computers include one or more computers associated with one or more treatment professionals, wherein the one or more treatment professionals have access to the digital model of the user’s teeth.

15. The dental scanning system of claim 14, wherein the computer network is further configured to send one or more diagnoses of a dental condition of the user’s teeth by the one or more treatment professionals from the one or more computers associated with one or more treatment professionals to the local computer.

16. The dental scanning system of claim 14, wherein at least one of the one or more remote computers is associated with an analysis center.

17. The dental scanning system of claim 14, wherein the database includes digital models of other user’s teeth with associated prior conditions and/or digital models of other user’s teeth while a treatment plan is being performed up to a final state of other user’s teeth at completion of the other user’s treatment plan.

18. The dental scanning system of claim 14, wherein the local computer is configured to display cross-sectional views of the user’s teeth, representations of segmented teeth, or cross-sectional views of the user’s teeth and representations of segmented teeth to the user.

19. The dental scanning system of claim 14, wherein the digital model includes an interior view including a root structure or an interior structure of one or more of the user’s teeth.

20. The dental scanning system of claim 14, wherein the treatment plan includes a timeline for the treatment plan, including scheduled office visits to the treatment professional.
